(19) United States
(12) Patent Application Publication
(10) Pub. No.: US 2025/0238862 A1
(43) Pub. Date: Jul. 24, 2025

(54) CONTROL METHOD, CONTROL DEVICE, AND RECORDING MEDIUM

(71) Applicant: Panasonic Intellectual Property Management Co., Ltd., Osaka (JP)

(72) Inventors: Kakuya YAMAMOTO, Hyogo (JP); Naohisa NISHIDA, Kanagawa (JP); Yasushi TAKAHASHI, Fukuoka (JP); Ayaka NAKASAKA, Osaka (JP)

(21) Appl. No.: 19/069,422

(22) Filed: Mar. 4, 2025

Related U.S. Application Data
(63) Continuation of application No. PCT/JP2023/034936, filed on Sep. 26, 2023.
(60) Provisional application No. 63/410,818, filed on Sep. 28, 2022.

(51) Int. Cl. G06Q 40/04

(52) U.S. Cl. CPC G06Q 40/04

(57) ABSTRACT

A control method for controlling a device includes: obtaining first model data representing a first object model that is virtual; generating, based on the first model data obtained, a first non-fungible token (NFT) that is an NFT corresponding to the first model data and includes first position information indicating a position of a first region in a metaverse in which the first object model is placed; and determining, based on the first NFT and the first position information, a first distribution target of a first profit corresponding to a first price, when the first NFT is traded at the first price.

### CROSS REFERENCE TO RELATED APPLICATIONS

This is a continuation application of PCT International Application No. PCT/JP2023/034936 filed on Sep. 26, 2023, designating the United States of America, which is based on and claims priority of U.S. Provisional Patent Application No. 63/410,818 filed on Sep. 28, 2022. The entire disclosures of the above-identified applications, including the specifications, drawings and claims are incorporated herein by reference in their entirety.

### FIELD

The present disclosure relates to control methods, control devices, and recording media.

### BACKGROUND

Patent Literature (PTL) 1 discloses a technique to trade a non-fungible token (NFT) that is used to guarantee the uniqueness of digital content or prove the ownership of digital content.

### CITATION LIST

### Patent Literature

PTL 1: Japanese Patent No. 7129579

### SUMMARY

### Technical Problem

An object of the present disclosure is to provide a control method, etc., in which profit from trading an NFT corresponding to digital content can be properly distributed to a user who has been involved in creating the digital content.

### Solution to Problem

A control method according to one aspect of the present disclosure, which is a device control method, includes: obtaining first model data representing a first object model that is virtual; generating, based on the first model data obtained, a first non-fungible token (NFT) that is an NFT corresponding to the first model data and includes first position information indicating a position of a first region in a metaverse, the first region being a region in which the first object model is placed; and determining, based on the first NFT and the first position information, a first distribution target of a first profit corresponding to a first price, when the first NFT is traded at the first price.

A control device according to one aspect of the present disclosure includes: a processor; and memory, and using the memory, the processor: obtains first model data representing a first object model that is virtual; generates, based on the first model data obtained, a first non-fungible token (NFT) that is an NFT corresponding to the first model data and includes first position information indicating a position of a first region in a metaverse, the first region being a region in which the first object model is placed; and determines, based on the first NFT and the first position information, a first distribution target of a first profit corresponding to a first price, when the first NFT is traded at the first price.

Note that these general and specific aspects may be implemented using a system, a device, an integrated circuit, a computer program, or a computer-readable recording medium such as compact disc read-only memory (CD-ROM), or any combination of systems, devices, integrated circuits, computer programs, and recording media.

### Advantageous Effects

According to the control method, etc., according to the present disclosure, profit from trading an NFT corresponding to digital content can be properly distributed to a user who has been involved in creating first model data as the digital content. Furthermore, it is possible to reduce memory, energy, etc., required in the process of user search, inquiry, or the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the configuration of a system according to the present embodiment.

FIG. 2 is a block diagram illustrating one example of the configuration of a virtual space management server according to the present embodiment.

FIG. 3 is a sequence diagram for describing one example of a model data recording process in a system according to the embodiment.

FIG. 4 is a sequence diagram for describing one example of a first NFT generation process in a system according to the embodiment.

FIG. 5 is a sequence diagram illustrating one example of a profit distribution method in a system according to the embodiment.

FIG. 6 is a diagram for describing one example of trading of an object model.

FIG. 7 is a sequence diagram illustrating one example of a profit distribution method in a system according to Variation 1.

FIG. 8 is a sequence diagram illustrating one example of a profit distribution method in a system according to Variation 2.

FIG. 9 is an explanatory diagram illustrating the data structure of a blockchain.

FIG. 10 is an explanatory diagram illustrating the data structure of transaction data.

### DESCRIPTION OF EMBODIMENT

### (Underlying Knowledge Forming Basis of the Present Disclosure)

In recent years, a variety of digital content is managed in association with NFTs. By using NFTs, it is possible to ensure the uniqueness of digital content and easily specify the owner of digital content.

When it is assumed that a three-dimensional virtual object placed in a metaverse is to be traded, there is no system that distributes the profit from the sale of the three-dimensional object to not only the owner of the three-dimensional object, but also a user engaged on the three-dimensional object. Possible examples of the user engaged on the three-dimensional object include the owner of a location in the metaverse at which the three-dimensional object is placed and the creator of the three-dimensional object. When the three-dimensional object has been created on the basis of an object in a physical space, the user engaged on the three-dimensional object may be the owner of the object in the physical space or the owner of a location (space) at which the object in the physical space is placed. With the existing system, it is difficult to specify such a user engaged on the three-dimensional object.

The inventors found a control method, etc., in which profit from trading an NFT corresponding to digital content can be properly distributed to a user who has been involved in creating the digital content.

A control method according to the first aspect of the present disclosure, which is a device control method, includes: obtaining first model data representing a first object model that is virtual; generating, based on the first model data obtained, a first non-fungible token (NFT) that is an NFT corresponding to the first model data and includes first position information indicating a position of a first region in a metaverse, the first region being a region in which the first object model is placed; and determining, based on the first NFT and the first position information, a first distribution target of a first profit corresponding to a first price, when the first NFT is traded at the first price.

With this, since the first NFT including the first position information is generated, it is possible to properly determine the first distribution target of the first profit that is obtained when the first NFT is traded at the first price. For example, it is possible to determine, as the first distribution target, the first owner who owns the first region specified on the basis of the first position information in addition to the second owner who owns the first NFT. Thus, profit from trading an NFT corresponding to digital content can be properly distributed to a user who has been involved in creating the first model data as the digital content.

Furthermore, a user who is to be the first distribution target can be properly determined from among a plurality of users and therefore, it is possible to reduce memory, energy, etc., required in the process of user search, inquiry, or the like.

A control method according to the second aspect of the present disclosure is the control method according to the first aspect in which the first NFT further includes first creator information for identifying a first creator who has created the first object model, and the first distribution target includes the first creator and a first owner who owns the first region specified based on the first position information.

With this, it is possible to distribute the first profit to the first owner who owns the first region and the first creator who has created the first three-dimensional model.

A control method according to the third aspect of the present disclosure is the control method according to the first aspect or the second aspect in which the first NFT further includes owner information for identifying a second owner who owns the first NFT, and the first distribution target includes the second owner and a first owner who owns the first region specified based on the first position information.

With this, it is possible to distribute the first profit to the first owner who owns the first region and the second owner who owns the first NFT.

A control method according to the fourth aspect of the present disclosure is the control method according to any one of the first aspect to the third aspect in which the first object model is created based on a three-dimensional object placed in a physical space, the first NFT further includes second position information indicating a position of a second region in the physical space, the second region being region in which the three-dimensional object is placed, and the first distribution target includes a first owner who owns the first region specified based on the first position information and a third owner who owns the second region specified based on the second position information.

With this, it is possible to distribute the first profit to the first owner who owns the first region and the third owner who owns the second region.

A control method according to the fifth aspect of the present disclosure is the control method according to any one of the first aspect to the fourth aspect in which the first object model includes a second object model and a third object model, the first NFT further includes first creator information for identifying a first creator who has combined the second object model and the third object model, second creator information for identifying a second creator who has created the second object model, and third creator information for identifying a third creator who has created the third object model, and the first distribution target includes the first creator, the second creator, the third creator, and a first owner who owns the first region specified based on the first position information.

With this, it is possible to distribute the first profit to the first owner who owns the first region, the first creator who has combined the second object model and the third object model, the second creator who has created the second object model, the third creator who has created the third object model, and the second owner who owns the first NFT.

A control method according to the sixth aspect of the present disclosure is the control method according to any one of the first aspect to the fifth aspect that further includes: storing, in a distributed ledger, the first NFT generated.

Thus, it is possible to keep the first NFT from being tampered with.

A control method according to the seventh aspect of the present disclosure is the control method according to the sixth aspect that further includes: accepting purchase information indicating that a purchaser purchases the first NFT at the first price; changing owner information for identifying a second owner who owns the first NFT from the second owner to the purchaser; and storing, in the distributed ledger, the first NFT that has been changed.

With this, since the owner information of the first NFT is changed from the second owner to the purchaser upon purchase and the first NFT that has been changed is stored in the distributed ledger, it is possible to record the history of changes in the owner information on the distributed ledger.

A control method according to the eighth aspect of the present disclosure is the control method according to any one of the first aspect to the seventh aspect that further includes: obtaining fourth model data created by a fourth creator and representing a fourth object model that is virtual; obtaining an action history of the fourth creator in the metaverse; generating, based on the fourth model data obtained, a second NFT that is an NFT corresponding to the fourth model data and includes third position information indicating a position of a third region in the metaverse, the third region being a region in which the fourth object model is placed; and determining, based on the second NFT and the third position information, a second distribution target of a second profit corresponding to a second price, when the second NFT is traded at the second price. When the fourth creator is determined, based on the action history, to have viewed the first object model, the second distribution target includes a first owner who owns the first region specified based on the first position information and a fourth owner who owns the third region specified based on the third position information.

With this, it is possible to properly determine the second distribution target of the second profit that is obtained when the second NFT is traded at the second price. In particular, when it is determined that the fourth creator has viewed the first object model, it is possible to also distribute the second profit to the first owner who owns the first region in which the first object model is placed. In other words, by determining that viewing the first object model has helped the fourth creator to create the fourth object model, it is possible to also distribute the second profit to a user who has been involved in creating the first object model. Thus, even if the fourth creator creates the fourth object model by copying the first object model and sells the fourth object model, it is possible to also distribute the profit from the sale to a user who has been involved in creating the first object model.

A control method according to the ninth aspect of the present disclosure is the control method according to the eighth aspect in which the action history includes a history of movement of the fourth creator in the metaverse, and when the history of movement shows that an amount of time for which the fourth creator has been located in an area within which the fourth creator is separated from the first object model by less than a predetermined distance is greater than or equal to a predetermined amount of time or a total number of times the fourth creator has been located in the area is greater than or equal to a predetermined number of times, the fourth creator is determined to have viewed the first object model.

With this, it is p possible to estimate the impact the first object model has on the fourth creator, and when the estimated impact is greater than a predetermined criterion, it can be determined that the first object model has been viewed.

A control method according to the tenth aspect of the present disclosure is the control method according to any one of the first aspect to the ninth aspect that further includes: obtaining fourth model data created by a fourth creator and representing a fourth object model that is virtual; generating, based on the fourth model data obtained, a second NFT that is an NFT corresponding to the fourth model data and includes third position information indicating a position of a third region in the metaverse, the third region being a region in which the fourth object model is placed; and determining, based on the second NFT and the third position information, a second distribution target of a second profit corresponding to a second price, when the second NFT is traded at the second price. When the fourth object model is similar to the first object model, the second distribution target includes a first owner who owns the first region specified based on the first position information and a fourth owner who owns the third region specified based on the third position information.

With this, it is possible to properly determine the second distribution target of the second profit that is obtained when the second NFT is traded at the second price. In particular, when the fourth object model is similar to the first object model, the second profit can also be distributed to the first owner who owns the first region in which the first object model is placed. Thus, even if the fourth creator creates the fourth object model by copying the first object model and sells the fourth object model, it is possible to also distribute the profit from the sale to a user who has been involved in creating the first object model.

A control method according to the eleventh aspect of the present disclosure includes: a processor; and memory, and using the memory, the processor: obtains first model data representing a first object model that is virtual; generates, based on the first model data obtained, a first non-fungible token (NFT) that is an NFT corresponding to the first model data and includes first position information indicating a position of a first region in a metaverse, the first region being a region in which the first object model is placed; and determines, based on the first NFT and the first position information, a first distribution target of a first profit corresponding to a first price, when the first NFT is traded at the first price.

With this, since the first NFT including the first position information is generated, it is possible to properly determine the first distribution target of the first profit that is obtained when the first NFT is traded at the first price. For example, it is possible to determine, as the first distribution target, the first owner who owns the first region specified on the basis of the first position information in addition to the second owner who owns the first NFT. Thus, profit from trading an NFT corresponding to digital content can be properly distributed to a user who has been involved in creating the first model data as the digital content.

A recording medium according to the twelfth aspect of the present disclosure is a non-transitory computer-readable recording medium having recorded thereon a program for causing a computer to execute the control method according to any one of the first aspect to the tenth aspect.

Note that these general and specific aspects may be implemented using a system, a device, an integrated circuit, a computer program, or a computer-readable recording medium such as a CD-ROM, or any combination of systems, devices, integrated circuits, computer programs, and recording media.

Hereinafter, embodiments will be described with reference to the drawings. Note that each embodiment described below shows one specific example of the present disclosure. The numerical values, shapes, materials, structural elements, the arrangement and connection of the structural elements, steps, the processing order of the steps, etc., shown in the following embodiment are mere examples, and are not intended to limit the present disclosure. Among the structural elements in the following embodiment, structural elements not recited in any one of the independent claims which indicate the broadest concepts are not necessarily required to achieve the object of the present disclosure, but are described as structural elements included in a more preferred embodiment.

### Embodiment 1

The present embodiment will describe a control method, etc., in which profit from trading an NFT corresponding to digital content can be properly distributed.

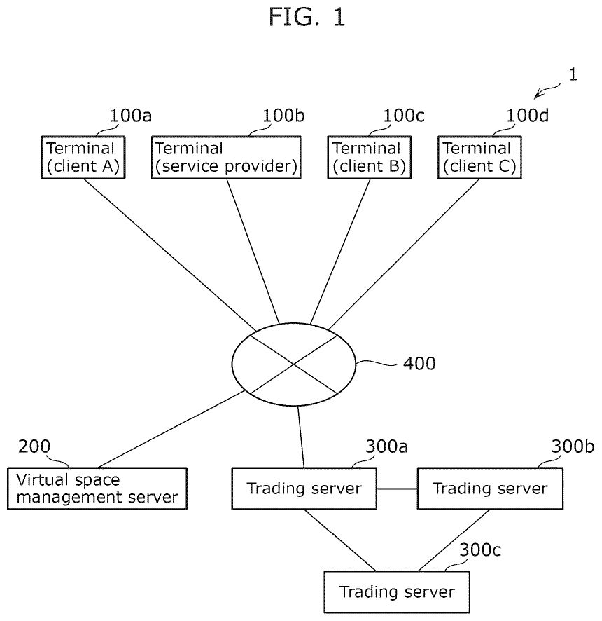

FIG. 1 is a block diagram illustrating the configuration of a system according to the present embodiment.

As illustrated in FIG. 1, system 1 includes terminals 100a to 100d, virtual space management server 200, and trading server 300a to 300c (also referred to as trading server 300a, etc.). Terminals 100a to 100d, virtual space management server 200, and trading servers 300a to 300c (also referred to as trading server 300, etc.) may all be connected to each other via network 400 or may all be directly connected in such a manner as to allow communication therebetween; alternatively, some of them may be connected via network 400 while some other are directly connected in such a manner as to allow communication therebetween. Network 400, which is the Internet or a cell-phone carrier network, for example, may include any communication line or network.

Clients A to C are users who experience a virtual space provided by virtual space management server 200. Clients A to C are users who trade three-dimensional objects in the virtual space.

Virtual space management server 200 is a server which is a computer that manages the virtual space. Virtual space management server 200 generates a virtual space and provides the virtual space to users by transmitting thereto VR data representing the virtual space, thus contributing to allowing the users to experience the virtual space. The virtual space is a three-dimensional or two-dimensional virtual space, for example. The virtual space can also be generally referred to as a metaverse. The VR data includes image data of an image showing a scene in the virtual space and may also include audio data representing sound and speech in the virtual space. In the virtual space, an item and an avatar may exist. The avatar may be associated with a person in the physical space.

Virtual space management server 200 allows client A to experience the virtual space using terminal 100a, for example. Virtual space management server 200 transmits the VR data to terminal 100a and receives information regarding the position and posture of the VR device (also referred to as position information) that is included in terminal 100a. Virtual space management server 200 is one example of the control device.

Furthermore, virtual space management server 200 allows trading of an item in the virtual space. In the trading of an item, a virtual currency is transferred from client A to a provider of the item upon transfer of the item from the provider to client A, for example. The virtual currency, which is Bitcoin or Ethereum, for example, is managed on a distributed ledger. The transfer of an item is managed on the distributed ledger as transfer of an NFT, for example.

Trading server 300a is a server that manages the transfer of a virtual currency using the distributed ledger. The distributed ledger is stored in storage of trading server 300a. When trading server 300a receives, from VR device 31, etc., transaction data indicating the transfer of a virtual currency, trading server 300a performs the process of storing the received transaction data in the distributed ledger. The transaction data indicating the transfer of the virtual currency includes the addresses of a source and a destination of the transfer of the virtual currency in a distributed ledger system.

Furthermore, using the distributed ledger, trading server 300a can manage the transfer of an item in the virtual space as the transfer of an NFT. When trading server 300a receives, from VR device 31, etc., transaction data indicating the transfer of an NFT, trading server 300a performs the process of storing the received transaction data in the distributed ledger. The transaction data indicating the transfer of the NFT includes the addresses of a source and a destination of the transfer of the NFT in the distributed ledger system.

At the time of storing new transaction data into the distributed ledger, trading server 300a stores the new transaction data in the distributed ledger in a method suitable for the type of the distributed ledger. Furthermore, trading server 300a, which is capable of transmitting and receiving communication data to and from other trading servers 300b, 300c, transmits said transaction data to other trading servers 300b, 300c and causes said transaction data to be stored into the distributed ledgers included in other trading servers 300b, 300c. At the time of storing the transaction data, a consensus may be built according to a consensus algorithm before the transaction data is stored. The transaction data stored in the distributed ledger is managed in a tamper-resistant way using properties such as a hash value (which will be described later).

For example, when the distributed ledger is a blockchain, trading server 300a generates a block including new transaction data, builds a consensus on the generated block among trading servers 300a, etc., according to the consensus algorithm, and stores said block in the distributed ledger. Note that the type of the distributed ledger is not limited to that described above; a distributed ledger of another type (for example, IOTA or a hash graph) may also be used.

Trading servers 300b, 300c, which are substantially the same as trading server 300a, operate independently of trading server 300a.

Note that a trading server group including trading servers 300a, etc., can also be referred to as a distributed ledger network. The following describes an example in which the distributed ledger network includes three trading servers 300a, etc., but the number of trading servers 300a, etc., may be four or more.

The VR device is an information processing device that is included in each of terminals 100a to 100d, presents the virtual space to users who own terminals 100a to 100d, and is owned by each of the users. The VR device includes a central processing unit (CPU), memory, storage, a display screen, a loudspeaker, a sensor, and so on, and performs information processing by the CPU executing a predetermined program using the memory. The VR device may include a global positioning system (GPS) receiver that obtains the position of the VR device on the earth. The VR device is mounted on a user's head, for example, and is generally referred to as VR goggles or a VR headset.

The VR device receives VR data from virtual space management server 200, displays an image showing a scene visible in the virtual space on the display screen using image data included in the VR data, and thus presents the image to the user. Furthermore, using audio data included in the VR data, the VR device can cause the loudspeaker to output sound and speech audible in the virtual space, and thus present the sound and speech to the user.

Furthermore, the VR device obtains the position information of the VR device by a sensor (such as a three-axis acceleration sensor or a three-axis gyroscope) and transmits the position information to virtual space management server 200. The transmitted position information is used by virtual space management server 200 to generate VR data, and the VR data calculated in consideration of the transmitted position information is subsequently transmitted.

Furthermore, the VR device transmits, to virtual space management server 200, information indicating an operation performed by a user on the VR device (also referred to as operation information). The operation information may include, for example, an operation to select one action from options of actions in the virtual space (that are so-called a selection menu or the like). The transmitted operation information is reflected in the position information of the user in the virtual space (in other words, an avatar corresponding to the user), and VR data based on the position information in which the transmitted operation information has been reflected is subsequently transmitted.

The VR device holds, in the storage, value information indicating at least a portion of environmental value owned by the user.

Terminal 100a is an information processing terminal owned by client A as a user. Terminal 100a, which includes a CPU, memory, storage, a display screen, and so on, performs information processing by the CPU executing a predetermined program using the memory. Terminal 100a is a smartphone, a tablet, a personal computer, or the like, for example.

Note that terminal 100b is an information processing terminal owned by a service provider as a user. Terminal 100c is an information processing terminal owned by client B as a user. Terminal 100d is an information processing terminal owned by client C as a user. Each of terminals 100b to 100d has substantially the same configuration as terminal 100a.

Note that a device group including virtual space management server 200 and trading server 300a, etc., which is a device group related to NFT trading in the virtual space, can also be called an NFT network. Note that the “NFT” is not limited to those defined by the Ethereum standard, ERC-721, and may be any token that is not fungible. The “token” may also be any data issued in association with data, a physical object, or the like.

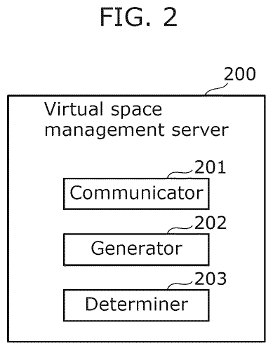

FIG. 2 is a block diagram illustrating one example of the configuration of the virtual space management server according to the present embodiment.

As illustrated in FIG. 2, virtual space management server 200 includes communicator 201, generator 202, and determiner 203. Communicator 201, generator 202, and determiner 203 can be implemented by a processor (for example, a central processing unit (CPU)) (not illustrated in the drawings) included in virtual space management server 200 executing a predetermined program using memory (not illustrated in the drawings).

Communicator 201 obtains first model data representing a first object model that is virtual. For example, communicator 201 obtains the first model data from terminal 100a owned by client A. The first object model is a virtual object created by client A and having a three-dimensional shape. The first object model may be a virtual three-dimensional object created on a computer by client A or may be a virtual three-dimensional object created on the basis of a physical three-dimensional object placed in a physical space. The first object model to be created by the latter method may be created by feature-point matching on a plurality of images of the physical three-dimensional object captured by client A with a camera from a plurality of viewpoints or may be created by scanning the physical three-dimensional object by client A with a distance sensor such as a light detection and ranging (LIDAR) or time-of-flight (TOF) sensor. The first object model may include: position information indicating a plurality of positions on a surface of the object; and attribute information including the color, the reflectance, and the like at each of the plurality of positions. Note that communicator 201 is one example of the obtainer. Note that the object model does not need to be a three-dimensional model and may be a two-dimensional model or may be video including a plurality of two-dimensional models arranged on the time axis. Each of the plurality of two-dimensional models included in the video is associated with the time of presentation, which is time with respect to video playback start time as a reference.

Note that the first object model may be formed by combining two or more three-dimensional object models. In other words, the first object model may include the second object model and the third object model.

On the basis of the first model data obtained, generator 202 generates a first non-fungible token (NFT) which is an NFT corresponding to the first model data. The first NFT includes first position information indicating the position of a first region in the metaverse in which the first object model is placed. The first NFT may further include first creator information for identifying a first creator who has created the first object model. Specifically, the first creator is client A, for example, and the first creator information is information for identifying client A. Moreover, the first NFT may further include owner information for identifying a second owner who owns the first NFT. In addition, the first NFT may further include second position information indicating the position of a second region in which a physical three-dimensional object from which the first object model originates is placed.

When the first object model is formed by combining two or more three-dimensional object models, the first NFT may further include: first creator information for identifying a first creator who has combined a second object model and a third object model; second creator information for identifying a second creator who has created the second object model; and third creator information for identifying a third creator who has created the third object model.

When generator 202 generates the first NFT, generator 202 transmits the first NFT to trading servers 300a to 300c via communicator 201. Thus, the first NFT is stored in the distributed ledger included in each of trading servers 300a to 300c.

In this manner, the first NFT may include information for specifying a user who has been involved in creating the first object model indicated in the first model data to which the first NFT corresponds. Note that the first position information may be stored in virtual space management server 200 or another device in association with first owner information for identifying a first owner who owns the first region. Thus, the first owner can be specified on the basis of the first position information. The second position information may be stored in virtual space management server 200 or another device in association with third owner information for identifying a third owner who owns the second region. Thus, the third owner can be specified on the basis of the second position information.

When the first NFT is traded at a first price, determiner 203 determines, on the basis of the first NFT and the first position information, a first distribution target of the first profit corresponding to the first price. Specifically, the first distribution target includes one or more users who are specified on the basis of information that is included in the first NFT to specify one or more users who have been involved in creating the first object model. For example, the information for specifying one or more users who have been involved in creating the first object model includes at least the first position information and the first creator information among the first creator information, the first position information, second owner information, the second position information, the second creator information, and the third creator information. Determiner 203 specifies, on the basis of the information stored in virtual space management server 200, the first owner associated with the first position information. Furthermore, determiner 203 specifies, on the basis of the information stored in virtual space management server 200, the third owner associated with the second position information. Note that the second owner information, which is one example of the owner information, is information for identifying the second owner who owns the first NFT.

The first distributed target may include: the first owner who owns the first region specified on the basis of the first position information; and the first creator specified according to the first creator information. Alternatively, the first distribution target may include: the first owner who owns the first region specified on the basis of the first position information; and the second owner. Alternatively, the first distribution target may include: the first owner who owns the first region specified on the basis of the first position information; and the third owner who owns the second region specified on the basis of the second position information. The first distributed target may include: the first owner who owns the first region specified on the basis of the first position information; the first creator; the second creator; and the third creator.

Note that each of the first creator, the second creator, the third creator, the first owner, the second owner, and the third owner is a user in system 1.

Furthermore, communicator 201 may accept purchase information indicating that a purchaser purchases the first NFT at the first price. When communicator 201 accepts the purchase information, generator 202 generates the first NFT by changing the owner information therein from the current owner (an owner who is eligible when the purchase information is accepted) (for example, the second owner) to the purchaser identified according to the purchase information. Subsequently, generator 202 transmits the first NFT with the changed owner information to trading servers 300a to 300c via communicator 201. Thus, the first NFT that has been changed is stored in the distributed ledger included in each of trading servers 300a to 300c.

### [Operation, Etc., of System]

Next, the operation of the system configured as described above will be described.

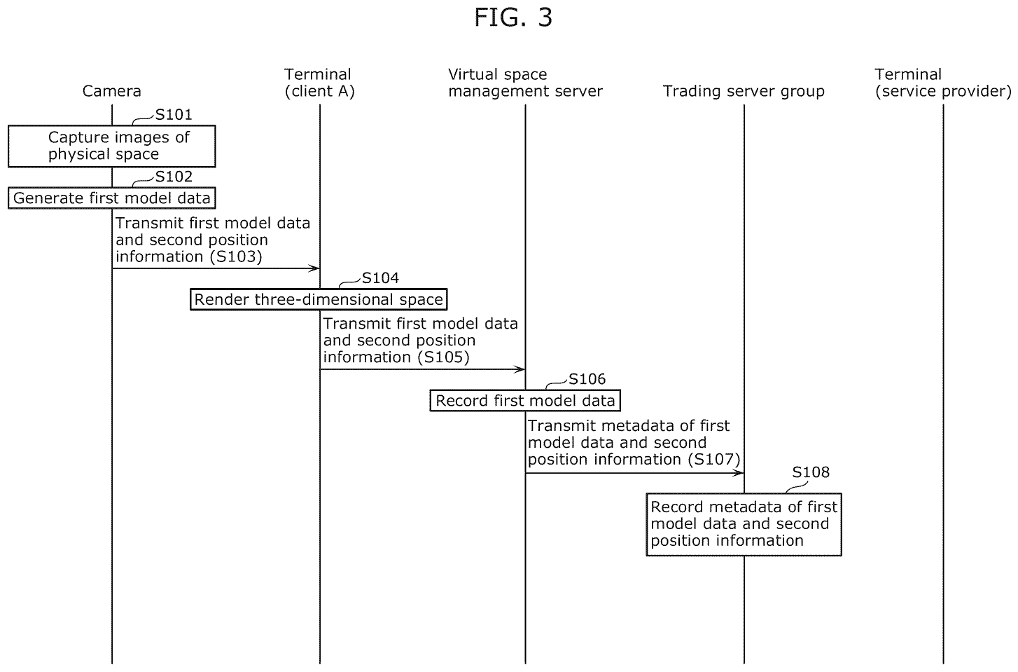

FIG. 3 is a sequence diagram for describing one example of a model data recording process in the system according to the embodiment. In this example, client A captures images of a physical three-dimensional object with a camera and creates the first model data on the basis of a plurality of images captured.

First, client A captures images of a physical space with a camera, for example (S101). For example, client A captures images of a three-dimensional object located in the physical space by moving the camera to a plurality of viewpoints so that images captured from the plurality of different viewpoints can be obtained. Thus, the plurality of images captured from the plurality of different viewpoints are obtained.

Next, the camera performs feature-point matching using the plurality of images to generate a plurality of three-dimensional points corresponding to a plurality of feature points, respectively. This means that model data representing a three-dimensional object model formed of the plurality of three-dimensional points is generated (S102). Note that Step S102 may be performed in terminal 100a. In this case, the plurality of images obtained by the camera are transmitted to terminal 100a.

Next, the camera transmits the model data and the second position information to terminal 100a of client A (S103). The second position information is a position indicating a region in which the physical three-dimensional object is placed. The second position information may be input by client A to the camera or may be the result of detection by a position detection sensor (for example, a global positioning system (GPS) sensor) included in the camera. Note that in the case where terminal 100a performs Step S102, the second position information may be input to terminal 100a.

Next, terminal 100a renders a three-dimensional space on the basis of the model data (S104).

Next, terminal 100a transmits the model data and the second position information to virtual space management server 200 (S105). Note that Step S104 is not required to be performed.

Next, virtual space management server 200 records the model data (S106).

Virtual space management server 200 transmits the metadata of the model data and the second position information to trading servers 300a to 300c (S107). The metadata of the model data is the metadata of the NFT. The metadata includes at least one of the location where the model data is placed (URI or country), the hash value, size, and type of the model data, a thumbnail (a representative image), information regarding a physical object (the images of which have been captured) from which the model data originates, the position (latitude and longitude, country, or region) or the area of the physical space, the owner or the right holder thereof, information regarding generation (capturing images) of the model data, information indicating a photographer or the date and time on which images are captured (scanned), photographic equipment, a photographic method, and information indicating an ambient environment, information regarding recording of the model data (in the trading servers), information indicating persons who record and transmit the model data and the time at which the model data is recorded and transmitted, other data related to the model data, other data closely related in terms of time, location, or personal relationship of persons concerned, the ID of said other data, and the NFT, etc., of said other data, for example.

Trading servers 300a to 300c record the metadata of the model data and the second position information on the distributed ledger by executing a consensus algorithm (S108).

Note that when the model data is generated on a computer according to an operation performed by a user instead of being generated on the basis of the physical three-dimensional object, the second position information is absent and thus, the second position information is not recorded on the distributed ledger in trading servers 300a to 300c. This allows for reduced memory consumption.

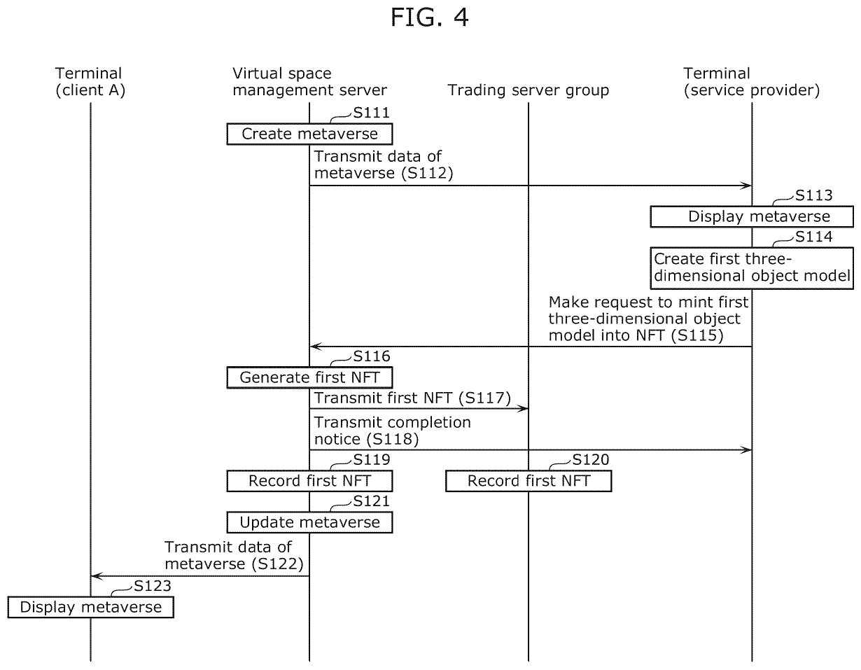

FIG. 4 is a sequence diagram for describing one example of a first NFT generation process in the system according to the embodiment.

Virtual space management server 200 creates a metaverse on the basis of virtual space data for reproducing a metaverse including the model data stored at this moment (S111).

Virtual space management server 200 transmits data of the created metaverse to terminal 100b of a service provider (S112). The service provider, which is a business operator that creates and installs a three-dimensional object in a physical space, for example, is a building contractor, for example.

Terminal 100b displays the metaverse on the basis of the data of the metaverse received from virtual space management server 200 (S113).

Terminal 100b creates the first object model by editing the three-dimensional object model included in the metaverse (S114). Editing the three-dimensional object model includes changing the shape of a portion of the three-dimensional object model, changing the color of at least a portion of the three-dimensional object model, adding a new three-dimensional object model to the three-dimensional object model, and deleting a portion of the three-dimensional object model, for example. For example, terminal 100b may edit a portion of the three-dimensional object model created by capturing images of a kitchen of client A and thus create a three-dimensional object model of a remodeled kitchen as the first object model. The remodeled kitchen is, for example, the kitchen that has equipment partially replaced or the kitchen that has been partially changed in color, material, etc.

As requested by client A, terminal 100b edits the three-dimensional object model created by client A. The request from client A may be accepted via terminal 100a; alternatively, on the basis of the request from client A to the service provider in the real world, the service provider may accept the request to edit the three-dimensional object model. The request may include permission information for permitting editing the three-dimensional object model created by client A. This means that the three-dimensional object model created by client A is not editable without the permission information; when the permission information is provided, the three-dimensional object model created by client A may be made editable.

Terminal 100b transmits, to virtual space management server 200, request information indicating the request to mint the created first object model into an NFT (S115). Thus, terminal 100b requests virtual space management server 200 to mint the first object model into an NFT. Note that the request information may include: the first model data representing the first object model; name information indicating the name of the NFT; the first position information indicating the position of the first region in the metaverse in which the first object model is placed; and material information from which the first object model originates. The material information may be an NFT corresponding to another three-dimensional object model.

Virtual space management server 200 generates the first NFT by minting the first object model into an NFT according to the request information (S116), transmits the generated first NFT to trading servers 300a to 300c (S117), and transmits, to terminal 100b, a completion notice indicating that the generation of the first NFT has been completed (S118). The first NFT may include: NFT_ID for identifying the first NFT; the name information; data identification information for identifying the first model data corresponding to the first NFT (for example, a uniform resource identifier (URI) of the first model data); and the creator of the first object model (client A) and/or the owner of the first NFT (service provider). The first NFT may further include the first position information and the material information. Subsequently, virtual space management server 200 records the first NFT generated (S119). Specifically, the first NFT is stored into the storage included in virtual space management server 200.

By executing a consensus algorithm, trading servers 300a to 300c record, on the distributed ledger, the first NFT received from virtual space management server 200 (S120).

On the basis of the first NFT recorded, virtual space management server 200 updates the metaverse including the first object model corresponding to the first NFT (S121).

Virtual space management server 200 transmits the data of the updated metaverse to terminal 100a of client A, for example (S122). Virtual space management server 200 may perform Step S122 when requested from terminal 100a, for example.

Terminal 100a displays the metaverse on the basis of the data of the updated metaverse received from virtual space management server 200 (S123). Thus, client A can view, via terminal 100a, the metaverse in which the first object model has been reflected.

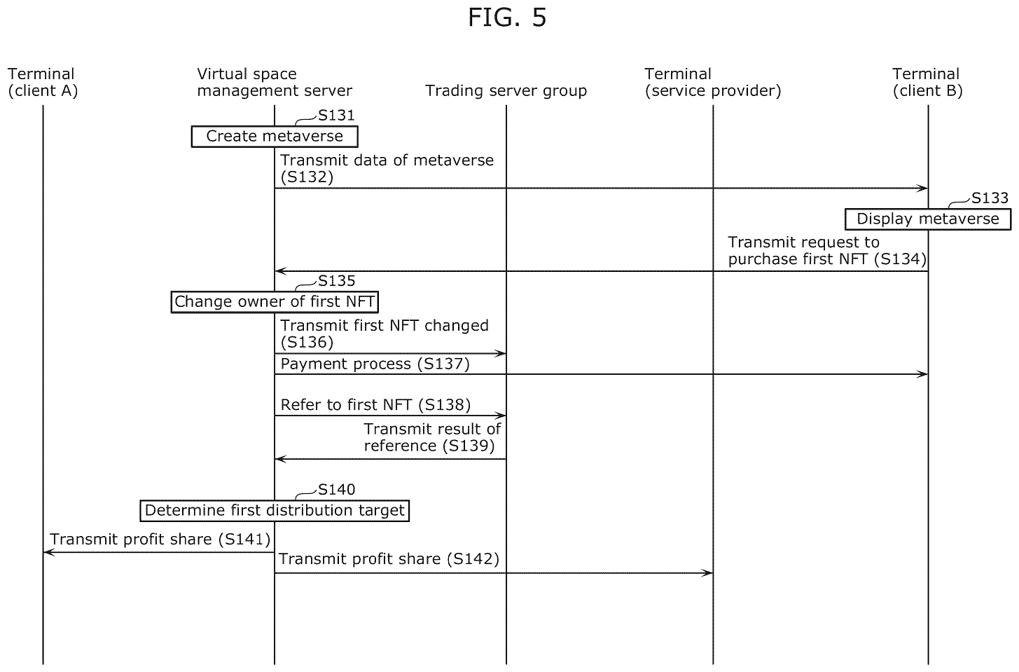

FIG. 5 is a sequence diagram illustrating one example of a profit distribution method in the system according to the embodiment. FIG. 5 shows an example where the service provider sells the first NFT to client B.

Virtual space management server 200 creates a metaverse on the basis of virtual space data for reproducing a metaverse including the model data stored at this moment (S131).

Virtual space management server 200 transmits data of the created metaverse to terminal 100c of client B (S132). Client B plans to purchase the first object model, for example.

Terminal 100c displays the metaverse on the basis of the data of the metaverse received from virtual space management server 200 (S133).

Terminal 100c transmits, to virtual space management server 200, purchase request information indicating a request to purchase the first NFT corresponding to the first model data representing the first object model created (S134). Thus, terminal 100c requests virtual space management server 200 to purchase the first NFT.

Virtual space management server 200 changes the owner of the first NFT from the service provider to client B on the basis of the purchase request information received from terminal 100c (S135). Virtual space management server 200 generates the first NFT with the owner changed, and transmits, to trading servers 300a to 300c, the first NFT that has been changed (S136). Thus, the first NFT that has been changed is recorded on the distributed ledger in each of trading servers 300a to 300c. The owner information indicating the owner of the first NFT included in the first NFT that has been changed indicates client B.

Virtual space management server 200 and terminal 100c perform a payment process (S137). Specifically, a first amount of tokens corresponding to the first price of the first NFT are transferred from the digital account of client B linked to terminal information of terminal 100c (or client information of client B) to the digital account of virtual space management server 200. Specifically, the first amount of tokens are reduced from the balance on the digital account of client B, and the balance on the digital account of virtual space management server 200 increases by the first amount of tokens.

In order to obtain information for determining a profit distribution target, virtual space management server 200 refers to the first NFT by accessing the distributed ledger managed by each of trading servers 300a to 300c (S138). Trading servers 300a to 300c transmit the first position information, the creator of the first object model, the owner of the first NFT, and the material information, which are included in the first NFT, to virtual space management server 200 as a result of reference, for example (S139). The material information included as the result of reference includes information for specifying a user who has been involved in creating the three-dimensional object model indicated in the model data corresponding to the NFT specified according to the material information, for example.

On the basis of the result of reference, virtual space management server 200 determines the first distribution target of the first profit (S140). For example, virtual space management server 200 determines, as the first distribution target, the service provider who is the owner of the first NFT before purchase as well as being the owner of the first region in the metaverse in which the first object model is placed, and client A who is the creator of the first object model.

Virtual space management server 200 transmits information indicating the profit share of client A to terminal 100a (S141), and transmits information indicating the profit share of the service provider to terminal 100b (S142). Thus, the profit share is paid from the digital account of virtual space management server 200 to the digital account of client A linked to terminal information of terminal 100a (client information of client A), and the profit share is paid from the digital account of virtual space management server 200 to the digital account of the service provider linked to terminal information of terminal 100b (or service provider information of the service provider).

### [Use Case]

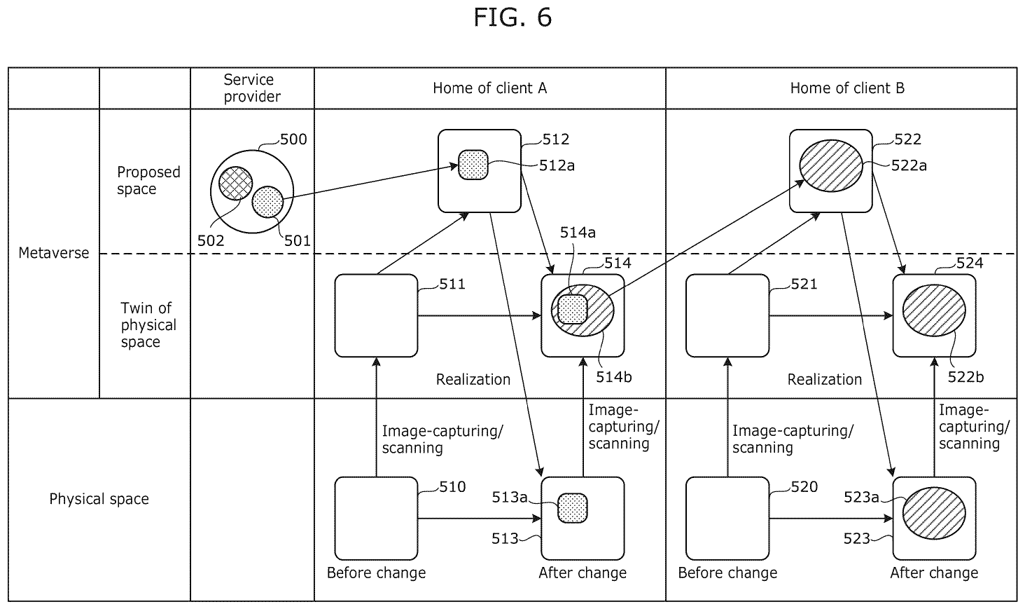

FIG. 6 is a diagram for describing one example of trading of the three-dimensional object model.

For example, assume that the service provider proposes three-dimensional object models 501 and 502 of the kitchen in metaverse 500 of the service provider.

Assume that client A views metaverse 500 of the service provider and determines that three-dimensional object model 502 is to be applied to the home kitchen of client A.

Client A scans or captures images of home kitchen 510 (that is, a physical three-dimensional object) of client A and thus creates three-dimensional object model 511 that is a digital twin of kitchen 510.

The service provider incorporates three-dimensional object model 501 of the service provider into three-dimensional object model 511 of the kitchen of client A and thus creates edited three-dimensional object model 512 of the kitchen. Three-dimensional object model 512 includes three-dimensional object model 512a added thereto that is three-dimensional object model 501 edited.

Subsequently, on the basis of three-dimensional object model 512 created, the service provider remodels real-world kitchen 510 into kitchen 513 of three-dimensional object model 512 in the physical space. Kitchen 513 includes items (such as equipment) 513a realized from three-dimensional object model 512a.

Client A scans or captures images of remodeled kitchen 513 and thus creates three-dimensional object model 514 that is a digital twin of kitchen 513.

Three-dimensional object model 514 is expected to be viewed by another client B and used for remodeling of the kitchen of client B. In this case, by purchasing an NFT corresponding to three-dimensional object model 514, client B can use three-dimensional object model 514 to remodel the kitchen. Note that three-dimensional object model 514 is placed in the metaverse of the service provider and made viewable to another client B.

For example, assume that client B views updated metaverse space 500 of the service provider and determines to incorporate three-dimensional object model 514b included in three-dimensional object model 514 into the home kitchen of client B.

Client B scans or captures images of home kitchen 520 (that is, a physical three-dimensional object) of client B and thus creates three-dimensional object model 521 that is a digital twin of kitchen 520.

The service provider incorporates three-dimensional object model 514b into three-dimensional object model 521 of the kitchen of client B and thus creates edited three-dimensional object model 522 of the kitchen. Three-dimensional object model 522 includes three-dimensional object model 522a added thereto that is three-dimensional object model 514b edited.

Subsequently, on the basis of three-dimensional object model 522 created, the service provider remodels real-world kitchen 520 into kitchen 523 of three-dimensional object model 522 in the physical space. Kitchen 523 includes items (such as equipment) 523a realized from three-dimensional object model 522a.

Client B scans or captures images of remodeled kitchen 523 and thus creates three-dimensional object model 524 that is a digital twin of kitchen 523.

When an NFT corresponding to three-dimensional object model 524 of client B is sold to another client C, distribution targets are determined so that the profit from the sale is distributed to users who have been involved in creating three-dimensional object model 524. For example, client B who has created three-dimensional object model 524, the service provider who has proposed three-dimensional object model 522 from which three-dimensional object model 524 originates, the service provider who owns a region in the metaverse in which three-dimensional object model 524 is placed, and client A who has created three-dimensional object model 514 including three-dimensional object model 514b from which three-dimensional object model 522a of three-dimensional object model 522 originates, for example, may be determined as the distribution targets. Note that the distribution targets may include a user who has been involved in creating a three-dimensional object model from which one three-dimensional object model originates, that is, a material model. The distribution targets may also include a user who has been involved in creating a material model of said material model. In this case, it is possible to specify users who have been involved in creating the models over multiple generations; however, the upper limit of the number of generations to be traced back may be set.

### Advantageous Effects, Etc.

The control method according to the present embodiment is a method for controlling a control device (virtual space management server 200). In the control method, the control device obtains the first model data representing the first object model that is virtual (S115). On the basis of the first model data obtained, the control device generates the first non-fungible token (NFT) that is an NFT corresponding to the first model data and includes the first position information indicating the position of the first region in the metaverse in which the first object model is placed (S116). When the first NFT is traded at the first price, the control device determines, on the basis of the first NFT and the first position information, the first distribution target of the first profit corresponding to the first price.

Thus, since the control device generates the first NFT including the first position information, it is possible to properly determine the first distribution target of the first profit obtained when the first NFT is traded at the first price. For example, it is possible to determine, as the first distribution target, not only the second owner who owns the first NFT, but also the first owner who owns the first region specified on the basis of the first position information. Thus, the profit from trading the NFT corresponding to digital content can be properly distributed to a user who has been involved in creating the first model data as the digital content.

Furthermore, in the control method according to the present embodiment, the first NFT may further include the first creator information for identifying the first creator who has created the first object model. The first distribution target may include: the first owner who owns the first region specified on the basis of the first position information; and the first creator.

Thus, it is possible to distribute the first profit to the first owner who owns the first region and the first creator who has created the first three-dimensional model.

Furthermore, in the control method according to the present embodiment, the first NFT may further include the owner information for identifying the second owner who owns the first NFT. The first distribution target may include: the first owner who owns the first region specified on the basis of the first position information; and the second owner.

Thus, it is possible to distribute the first profit to the first owner who owns the first region and the second owner who owns the first NFT.

Furthermore, in the control method according to the present embodiment, the first object model may be created on the basis of the three-dimensional object placed in the physical space. The first NFT may further include the second position information indicating the position of the second region in the physical space in which the three-dimensional object is placed. The first distribution target may include: the first owner who owns the first region specified on the basis of the first position information; and the third owner who owns the second region specified on the basis of the second position information.

Thus, it is possible to distribute the first profit to the first owner who owns the first region and the second owner who owns the second region.

Furthermore, in the control method according to the present embodiment, the first object model may include the second object model and the third object model. The first NFT may further include: the first creator information for identifying the first creator who has combined the second object model and the third object model; the second creator information for identifying the second creator who has created the second object model; and the third creator information for identifying the third creator who has created the third object model. The first distribution target may include: the first owner who owns the first region specified on the basis of the first position information; the first creator; the second creator; and the third creator.

Thus, it is possible to distribute the first profit to: the first owner who owns the first region; the first creator who has combined the second object model and the third object model; the second creator who has created the second object model; the third creator who has created the third object model; and the second owner who owns the first NFT.

Furthermore, in the control method according to the present embodiment, the control device may store, in the distributed ledger, the first NFT that has been generated (S120). Therefore, it is possible to keep the first NFT from being tampered with.

Furthermore, in the control method according to the present embodiment, the control device may accept the purchase information indicating that the purchaser purchases the first NFT at the first price (S134). The control device changes the owner information of the first NFT from the second owner to the purchaser (S135). The control device stores, in the distributed ledger, the first NFT that has been changed.

Thus, since the owner information of the first NFT is changed from the second owner to the purchaser upon purchase and the first NFT that has been changed is stored in the distributed ledger, it is possible to record the history of changes in the owner information on the distributed ledger.

### Variation 1

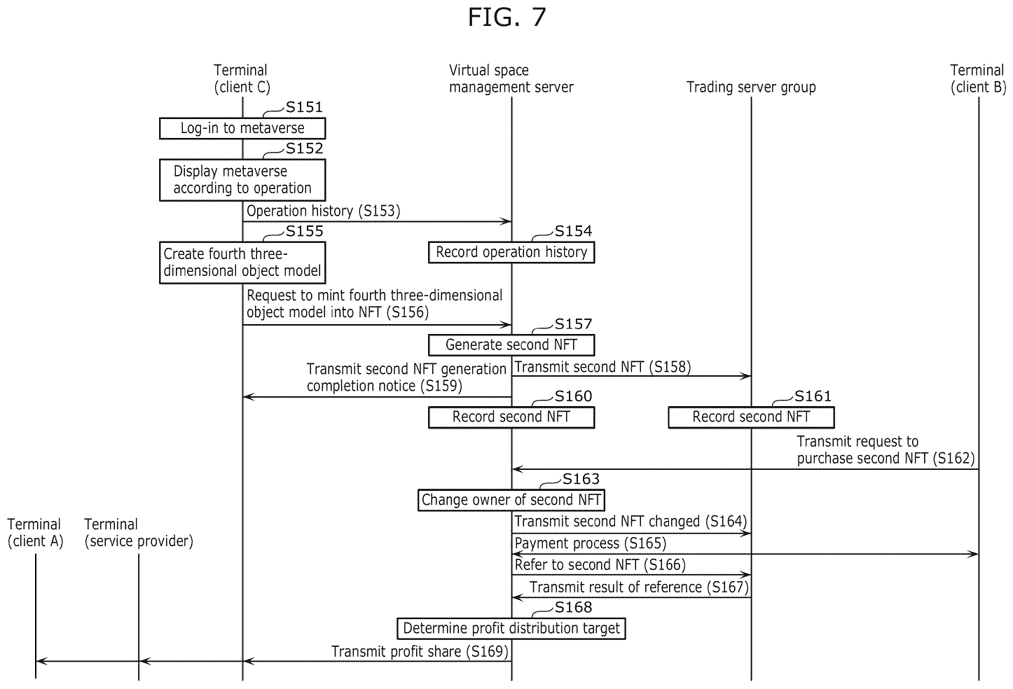

FIG. 7 is a sequence diagram illustrating one example of a profit distribution method in a system according to Variation 1.

Terminal 100d accepts an entry from client C and allows login to the metaverse (S151).

Terminal 100d displays the inside of the metaverse according to an operation performed by client C (S152).

Terminal 100d transmits an operation history to virtual space management server 200 (S153). The operation history, which is information indicating the operation performed by client C and accepted by terminal 100d, is sequentially transmitted to virtual space management server 200.

Virtual space management server 200 records the operation history received (S154).

Terminal 100d accepts an entry from client C and creates a fourth object model (S155). The fourth object model is a three-dimensional object model, for example.

Terminal 100d transmits, to virtual space management server 200, request information indicating a request to mint the created fourth object model into an NFT (S156). Thus, terminal 100d requests virtual space management server 200 to mint the fourth object model into an NFT. Note that the request information may include: fourth model data representing the fourth object model; name information indicating the name of the NFT; third position information indicating the position of a third region in the metaverse in which the fourth object model is placed; and material information from which the fourth object model originates. The material information may be an NFT corresponding to another three-dimensional object model.

Virtual space management server 200 generates the second NFT by minting the fourth object model into an NFT on the basis of the request information (S157), transmits the generated second NFT to trading servers 300a to 300c (S158), and transmits, to terminal 100d, a completion notice indicating that the generation of the second NFT has been completed (S159). The second NFT may include: NFT_ID for identifying the second NFT; the name information; data identification information (for example, a uniform resource identifier (URI) of the fourth model data) for identifying the fourth model data corresponding to the second NFT; and the creator of the fourth object model (client C) and/or the owner of the second NFT (client C). The second NFT may further include the third position information and the material information. Subsequently, virtual space management server 200 records the second NFT generated (S160). Specifically, the second NFT is stored into the storage included in virtual space management server 200.

By executing a consensus algorithm, trading servers 300a to 300c record, on the distributed ledger, the second NFT received from virtual space management server 200 (S161).

Terminal 100c transmits, to virtual space management server 200, purchase request information indicating a request to purchase the second NFT corresponding to the fourth model data representing the fourth object model (S162). Thus, terminal 100c requests virtual space management server 200 to purchase the second NFT.

On the purchase request information received from terminal 100c, virtual space management server 200 changes the owner of the second NFT from client C to client B (S163).

Virtual space management server 200 generates the second NFT with the owner changed, and transmits, to trading servers 300a to 300c, the second NFT that has been changed (S164). Thus, the second NFT that has been changed is recorded on the distributed ledger in each of trading servers 300a to 300c. The owner information indicating the owner of the second NFT included in the second NFT that has been changed indicates client B.

Virtual space management server 200 and terminal 100c perform the payment process (S165). Specifically, a second amount of tokens corresponding to the second price of the second NFT are transferred from the digital account of client B linked to the terminal information of terminal 100c (or the client information of client B) to the digital account of virtual space management server 200. Specifically, the second amount of tokens are reduced from the balance on the digital account of client B, and the balance on the digital account of virtual space management server 200 increases by the second amount of tokens.

In order to obtain information for determining a profit distribution target, virtual space management server 200 refers to the second NFT by accessing the distributed ledger managed by each of trading servers 300a to 300c (S166). Trading servers 300a to 300c transmit the third position information, the creator of the fourth object model, the owner of the second NFT, and the material information, which are included in the second NFT, to virtual space management server 200 as a result of reference, for example (S167). The material information included as the result of reference includes information for specifying a user who has been involved in creating the three-dimensional object model indicated in the model data corresponding to the NFT specified according to the material information, for example.

Virtual space management server 200 determines a second distribution target of the second profit on the basis of the result of reference and the operation history of client C who is a creator of the fourth object model (S168). When it is determined on the basis of the operation history that client C has viewed the first object model, virtual space management server 200 may determine, as the second distribution target, the first owner who owns the first region specified on the basis of the first position information and the fourth owner who owns the third region specified on the basis of the third position information. For example, virtual space management server 200 may determine, as the second distribution target, the service provider who is the owner of the first NFT before purchase as well as being the owner of the first region in the metaverse in which the first object model is placed, client C as the fourth owner, and client A who is the creator of the first object model.

Virtual space management server 200 transmits information indicating the profit share of client A to terminal 100a (S169), transmits information indicating the profit share of the service provider to terminal 100b (S169), and transmits information indicating the profit share of client C to terminal 100d (S169). Thus, the profit share is paid from the digital account of virtual space management server 200 to the digital account of client A linked to the terminal information of terminal 100a (or the client information of client A), the profit share is paid from the digital account of virtual space management server 200 to the digital account of the service provider linked to the terminal information of terminal 100b (or the service provider information of the service provider), and the profit share is paid from the digital account of virtual space management server 200 to the digital account of client C linked to the terminal information of terminal 100d (or the client information of client C).

Thus, it is possible to properly determine the second distribution target of the second profit that is obtained when the second NFT is traded at the second price. In particular, when it is determined that the fourth creator has viewed the first object model, the second profit can also be distributed to the first owner who owns the first region in which the first object model is placed. In other words, by determining that viewing the first object model has helped the fourth creator to create the fourth object model, it is possible to also distribute the second profit to a user who has been involved in creating the first object model. Thus, even if the fourth creator creates the fourth object model by copying the first object model and sells the fourth object model, it is possible to also distribute the profit from the sale to a user who has been involved in creating the first object model.

### Variation 2

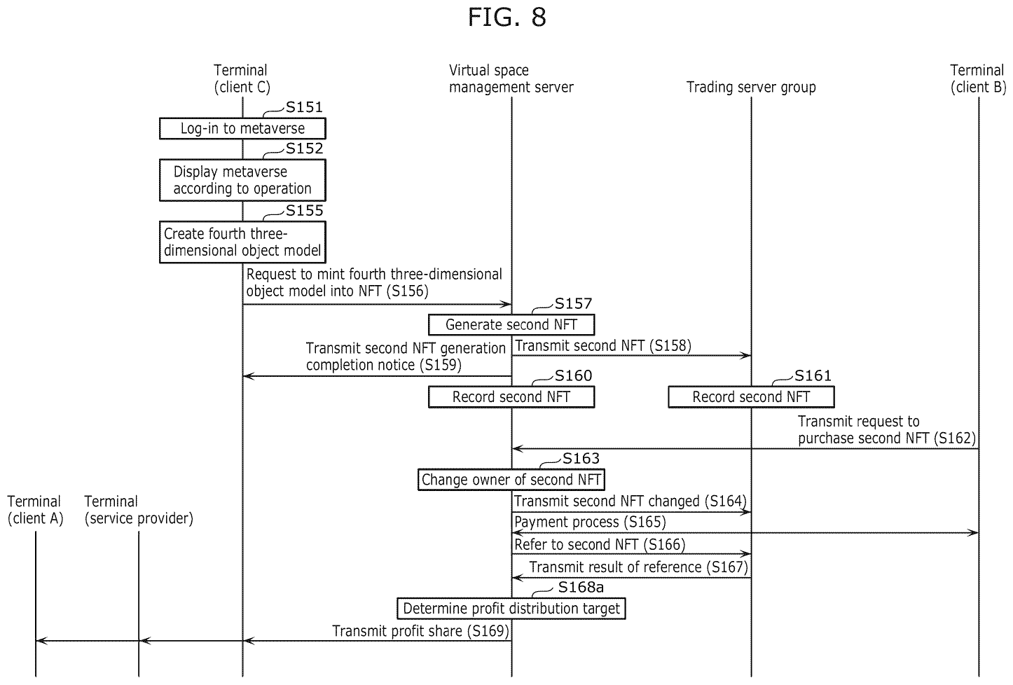

FIG. 8 is a sequence diagram illustrating one example of a profit distribution method in a system according to Variation 2. While the profit distribution target is determined on the basis of the operation history of the creator of the fourth object model in Variation 1, the profit distribution target is determined on the basis of how similar the fourth object model is to the first object model in Variation 2.

In Step S151 to Step S169, Steps S153, S154 are not performed and Step S168a is performed instead of Step S168 in Variation 2.

When the second NFT is traded at the second price, virtual space management server 200 determines the second distribution target of the second profit corresponding to the second price on the basis of the second NFT and the third position information (S168a). When the fourth object model is similar to the first object model, the second distribution target includes the first owner who owns the first region specified on the basis of the first position information and the fourth owner who owns the third region specified on the basis of the third position information.

Note that virtual space management server 200 may specify the first object model similar to the fourth object model by comparing all the plurality of three-dimensional object models in the metaverse in a brute-force way or may specify the first object model similar to the fourth object model by narrowing down the three-dimensional object models to a certain degree to those similar to the fourth object model in terms of classifications such as category, size, and color and then comparing the resultant three-dimensional object models in a brute-force way.

Thus, it is possible to properly determine the second distribution target of the second profit that is obtained when the second NFT is traded at the second price. In particular, when the fourth object model is similar to the first object model, the second profit can also be distributed to the first owner who owns the first region in which the first object model is placed. Thus, even if the fourth creator creates the fourth object model by copying the first object model and sells the fourth object model, it is possible to also distribute the profit from the sale to a user who has been involved in creating the first object model.

### Additional Comments

The following are additional comments on the distributed ledger according to the embodiment or the variations described above. A blockchain will be described herein as one example of the distributed ledger; the same is true for other distributed ledgers.

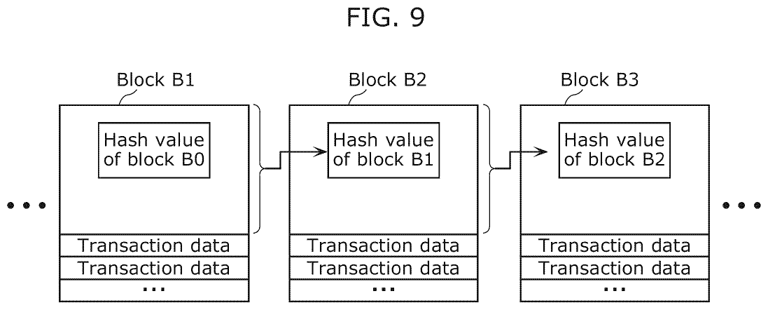

FIG. 9 is an explanatory diagram illustrating the data structure of the blockchain.

The blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks as hash values; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

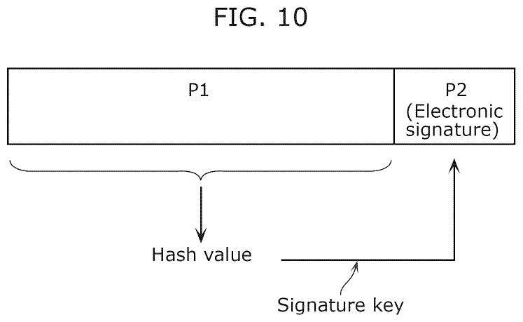

FIG. 10 is an explanatory diagram illustrating the data structure of the transaction data.

The transaction data illustrated in FIG. 10 includes transaction body P1 and digital signature P2. Transaction body P1 is a data body included in said transaction data. Digital signature P2 is generated for the hash value of transaction body P1 by using a signature key of a creator of said transaction data; more specifically, digital signature P2 is generated by encrypting said hash value with a private key of the creator of said transaction data. Examples of the type of the digital signature include the elliptic curve digital signature algorithm (ECDSA), CRYSTALS-Dilithium, Falcon, and SPHINCS+.

Because of including digital signature P2, the transaction data is virtually impossible to tamper with. This is because tampering with the transaction data will result in unsuccessful verification using digital signature P2, which reveals that the transaction data has been tampered with. Thus, transaction body P1 is protected from tampering.

Note that in the above-described embodiment or variations, each of the structural elements may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or semiconductor memory. Here, the software program for realizing the information processing device (specifically, the virtual space management server) or the like according to each of the above-described embodiment and variations is a program described below.

Specifically, this program causes a computer to perform an information processing method that is to be performed by an information processing device and includes: obtaining first model data representing a first object model that is virtual; generating, based on the first model data obtained, a first non-fungible token (NFT) that is an NFT corresponding to the first model data and includes first position information indicating a position of a first region in a metaverse, the first region being a region in which the first object model is placed; and determining, based on the first NFT and the first position information, a first distribution target of a first profit corresponding to a first price, when the first NFT is traded at the first price.

The information processing device (specifically, the virtual space management server) or the like according to one or more aspects has been described thus far based on the embodiment, but the present disclosure is not limited to this embodiment. Various modifications to the present embodiment and forms configured by combining structural elements in different embodiments that can be conceived by those skilled in the art may be included within the scope of one or more aspects as long as these do not depart from the essence of the present disclosure.

### INDUSTRIAL APPLICABILITY

The present disclosure is applicable to an information processing device that generates a virtual space.

1. A control method for controlling a device, the control method comprising:
obtaining first model data representing a first object model that is virtual;
generating, based on the first model data obtained, a first non-fungible token (NFT) that is an NFT corresponding to the first model data and includes first position information indicating a position of a first region in a metaverse, the first region being a region in which the first object model is placed; and
determining, based on the first NFT and the first position information, a first distribution target of a first profit corresponding to a first price, when the first NFT is traded at the first price.

2. The control method according to claim 1, wherein
the first NFT further includes first creator information for identifying a first creator who has created the first object model, and
the first distribution target includes the first creator and a first owner who owns the first region specified based on the first position information.

3. The control method according to claim 1, wherein
the first NFT further includes owner information for identifying a second owner who owns the first NFT, and
the first distribution target includes the second owner and a first owner who owns the first region specified based on the first position information.

4. The control method according to claim 1, wherein
the first object model is created based on a three-dimensional object placed in a physical space,
the first NFT further includes second position information indicating a position of a second region in the physical space, the second region being region in which the three-dimensional object is placed, and
the first distribution target includes a first owner who owns the first region specified based on the first position information and a third owner who owns the second region specified based on the second position information.

5. The control method according to claim 1, wherein
the first object model includes a second object model and a third object model,
the first NFT further includes first creator information for identifying a first creator who has combined the second object model and the third object model, second creator information for identifying a second creator who has created the second object model, and third creator information for identifying a third creator who has created the third object model, and
the first distribution target includes the first creator, the second creator, the third creator, and a first owner who owns the first region specified based on the first position information.

6. The control method according to claim 1, further comprising:
storing, in a distributed ledger, the first NFT generated.

7. The control method according to claim 6, further comprising:
accepting purchase information indicating that a purchaser purchases the first NFT at the first price;
changing owner information for identifying a second owner who owns the first NFT from the second owner to the purchaser; and
storing, in the distributed ledger, the first NFT that has been changed.

8. The control method according to claim 1, further comprising:
obtaining fourth model data created by a fourth creator and representing a fourth object model that is virtual;
obtaining an action history of the fourth creator in the metaverse;
generating, based on the fourth model data obtained, a second NFT that is an NFT corresponding to the fourth model data and includes third position information indicating a position of a third region in the metaverse, the third region being a region in which the fourth object model is placed; and
determining, based on the second NFT and the third position information, a second distribution target of a second profit corresponding to a second price, when the second NFT is traded at the second price, wherein
when the fourth creator is determined, based on the action history, to have viewed the first object model, the second distribution target includes a first owner who owns the first region specified based on the first position information and a fourth owner who owns the third region specified based on the third position information.

9. The control method according to claim 8, wherein
the action history includes a history of movement of the fourth creator in the metaverse, and
when the history of movement shows that an amount of time for which the fourth creator has been located in an area within which the fourth creator is separated from the first object model by less than a predetermined distance is greater than or equal to a predetermined amount of time or a total number of times the fourth creator has been located in the area is greater than or equal to a predetermined number of times, the fourth creator is determined to have viewed the first object model.

10. The control method according to claim 1, further comprising:
obtaining fourth model data created by a fourth creator and representing a fourth object model that is virtual;
generating, based on the fourth model data obtained, a second NFT that is an NFT corresponding to the fourth model data and includes third position information indicating a position of a third region in the metaverse, the third region being a region in which the fourth object model is placed; and
determining, based on the second NFT and the third position information, a second distribution target of a second profit corresponding to a second price, when the second NFT is traded at the second price, wherein
when the fourth object model is similar to the first object model, the second distribution target includes a first owner who owns the first region specified based on the first position information and a fourth owner who owns the third region specified based on the third position information.

11. A control device comprising:
a processor; and
memory, wherein
using the memory, the processor:
obtains first model data representing a first object model that is virtual;
generates, based on the first model data obtained, a first non-fungible token (NFT) that is an NFT corresponding to the first model data and includes first position information indicating a position of a first region in a metaverse, the first region being a region in which the first object model is placed; and
determines, based on the first NFT and the first position information, a first distribution target of a first profit corresponding to a first price, when the first NFT is traded at the first price.

12. A non-transitory computer-readable recording medium having stored therein a program for causing a computer to perform the control method according to claim 1.
